(19) United States
(12) Patent Application Publication
(10) Pub. No.: US 2008/0014556 A1
(43) Pub. Date: Jan. 17, 2008

(54) Tooth Implant

(76) Inventor: Stefan Neumeyer, Eschlkam (DE)

Correspondence Address: HOFFMAN WASSON & GITLER, P.C;CRYSTAL CENTER 2, SUITE 522, 2461 SOUTH CLARK STREET, ARLINGTON, VA, 22202-3843, US

(21) Appl. No.: 11/628,451

(22) PCT Filed: Jun. 2, 2005
(86) PCT No.: PCT/DE05/00992

§ 371 Date: Dec. 4, 2006

(30) Foreign Application Priority Data
Jun. 4, 2004 (DE) 10 2004 027 543.2
Jun. 4, 2004 (DE) 10 2004 061 792.9

(51) Int. Cl. A61C 8/00

(52) U.S. Cl. 433/174

(57) ABSTRACT

The invention relates to a tooth implant having an implant body with at least one intraosseous region that can be anchored in the bone, a penetration region for penetrating the soft tissue, and a coronal region with retention pegs, the regions being adjacent in the longitudinal axis of the implant body. The intraosseous region is made of at least three partial regions which are also adjacent in the direction of the longitudinal axis and have different threads.

### BACKGROUND OF THE INVENTION

The invention relates to a tooth implant with an implant corpus, which forms in its longitudinal axis consecutively at least one enossel area that can be anchored in a bone, an emergence area through a soft tissue and a corona area with retention pins.

Tooth implants are known in the art, for example from document EP 0 388 576 B1 or EP 0 668 751 B1. A tooth implant must generally be able to be anchored optimally in the jaw of the patient while withstanding a high degree of mechanical stress, with sufficient anchoring stability being achieved before complete healing. Furthermore, it is necessary to manufacture such implants from a biocompatible or a tissue-compatible material. Suitable materials for this purpose are, for example, titanium or titanium alloys, or also ceramics, such as in particular zirconium oxide ceramic. However, the use of several different materials is also possible; for example in the manner that a core area of the implant is made of titanium or a titanium alloy and the outer surface of the implant or implant corpus is made of a layer of ceramic, for example zirconium oxide. Implants made of multiple components are also conceivable.

Furthermore, it is necessary to design the tooth implant so that it can be inserted in place of a missing tooth between two existing teeth in the jaw of a patient.

The object of the invention is to present a tooth implant that can be fastened in the jaw of a patient with a minimum amount of time and effort and in such a manner that it possesses the high degree of anchoring stability required, especially after healing.

### SUMMARY OF THE INVENTION

This object is achieved by an implant with an implant corpus which forms in its longitudinal axis consecutively: at least one enossal area that can be anchored in a bone; an emergence area through a soft tissue; and a coronal area with retention pins. The enossal area is composed of at least three threaded sub-areas consecutively adjoining the longitudinal axis. The core of the implant corpus in both the apical sub-area and in the coronal sub-area has a cross-section that increases in at least one cross-section axis to the coronal area and has an essentially constant cross-section in the alveolar sub-area inbetween, and that the free ends or points of the threads are located on a common enveloping surface enclosing the longitudinal axis. The surface has its largest distance from the core of the implant corpus at the transition between coronal sub-area and the alveolar sub-area and the apical sub area and/or at the alveolar sub-area. The enossal area of the implant corpus has on its outer surface threads located on an envelope curve enclosing the longitudinal axis. The envelope curve in the apical sub-area and the coronal sub-area has a cross-section that increases at least in an axis direction radially to the longitudinal axis in the direction of the coronal area and has an essentially constant cross-section in the alveolar sub-are inbetween.

### BRIEF DESCRIPTION OF THE DRAWINGS

The invention is described below in more detail based on exemplary embodiments with reference to the drawings, in which:

FIG. 1 shows a simplified side view of a tooth implant according to the invention;

FIG. 2 shows an enlarged partial view of the transition between the emergence area and the adjacent coronal section or retention pin of the implant of FIG. 1;

FIG. 3 shows a cross section corresponding to line I-I through the emergence area of the implant;

FIGS. 4-6 show stylized forms of the retention pin;

FIG. 7 shows a simplified depiction of a retention pin of an implant for a front tooth in labial view;

FIG. 8 shows the retention pin of FIG. 7 in side view;

FIG. 9 shows the retention pin of an implant for a premolar in buccal/palatinal or lingual view;

FIG. 10 shows the retention pin of FIG. 9 in side view;

FIG. 11 shows the retention pin of an implant for a molar in buccal/palatinal or lingual view;

FIG. 12 shows the retention pin of FIG. 11 in side view, from mesial and distal view;

FIGS. 13-14 show in a side view similar to FIG. 1 and in top view a further possible embodiment of the implant according to the invention;

FIGS. 15-20 show various threaded sections of the implant of FIG. 13; and

FIGS. 21-27 show various threaded sections of an implant of a modified form as compared with the implant of FIG. 13.

### DETAILED DESCRIPTION OF THE INVENTION

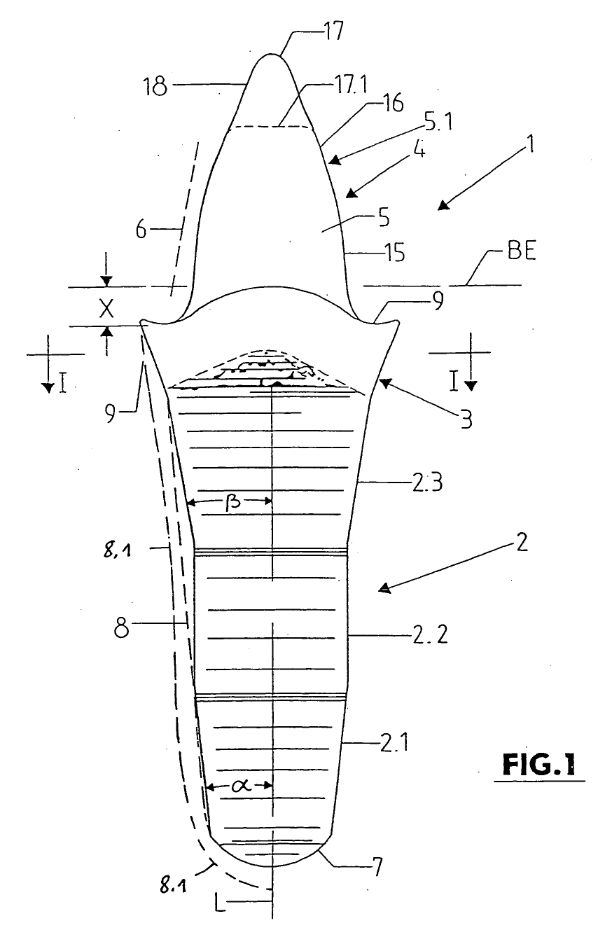

The tooth implant generally designated 1 in the drawings is manufactured in the depicted embodiment as a piece of at least one suitable material for tooth implants, e.g. of titanium and/or zirconium oxide, essentially with an elongated area 2 to be anchored in the jaw of a patient, a middle area or emergence area 3 adjoining the implant 1, with which the implant 1 emerges through the soft tissue after implanting and healing, and a coronal area 4, which is formed essentially by a retention pin 5, on which then for example a cap made of a preparable, difficult to prepare or non-preparable ceramic or made of other suitable metal and indicated in FIG. 1 by the broken line 6, is fastened as a support for the final prosthesis (e.g. crown or bridge, etc.).

In the depicted embodiment, the enossal area 2 consists of three sub-areas, which adjoin in longitudinal direction L and each of which is provided with outer threads, namely of the apical sub-area 2.1 furthest away from the coronal area 4, of an adjoining alveolar sub-area 2.2 and of an adjoining coronal sub-area 2.3, which then adjoins the emergence area 3, which increases in cross-section in the form of a truncated cone in the direction toward the retention pin.

In this enossal area 2 the core of the implant is formed so that said core has essentially the form of a truncated cone in sub-section 2.1 with a circular cross-section that enlarges toward the retention pin 5 and is rounded on its free end at 7. The taper angle α, i.e. the angle formed by a surface line extending parallel to the longitudinal axis L, is approximately 2 to 5° in the depicted embodiment.

In the sub-area adjoining the sub-area 2.1, the core of the implant has a cylindrical or essentially cylindrical form in relation to the longitudinal axis L, i.e. an essentially constant cross-section, which in the depicted embodiment is circular.

In the sub-area 2.3 adjoining the sub-area 2.2, the core of the implant again has a slightly truncated form, namely such that the core diameter increases in the direction of the retention pin 5, and the taper angle β, i.e. the angle formed by an imaginary surface line extending parallel to the longitudinal axis L, is smaller in the depicted embodiment than the taper angle of the emergence area 3 that increases toward the retention pin 5 in the manner of a truncated cone and is approximately on the order of the angle α, i.e. β is for example between 2 and 5°.

The core or core diameter are the cross-section area on which the base surface of the threads is located in the sub-areas 2.1, 2.2 and 2.3.

In FIGS. 1, 8 designates the surface line of an outer enveloping surface, which is depicted as a rotation surface of the surface line 8 on the longitudinal axis L and on which the free ends or points of the threads of the sub-sections 2.1, 2.2 and 2.3 are located. The rotation surface formed by the surface line 8 corresponds to the anatomical form of a tooth root. For this purpose, the surface line 8 or rotation surface is convexly curved on its outer side facing away from the longitudinal axis L, namely such that in the described embodiment of the implant core, the depth of the threads or the height of the threads in the sub-sections 2.1-2.3 initially increases in relation to the core starting from the end 7 in the sub-area 2.1, and then is largest starting at the transition between the sub-areas 2.1 and 2.2, in sub-area 2.2 and at the transition between the sub-areas 2.2 and 2.3, and then decreases again in sub-section 2.3.

The described embodiment of the implant and of the enossal area 2 features the advantage for example that the respective truncated cone design of the core in the sub-areas 2.1 and 2.3 achieves a secure anchoring of the implant corpus in the bone both at the lower, apical area and at the transition between the bone and the soft tissue, and that the larger depth of the threads in the sub-area 2.2 and also at the transition to sub-area 2.3 in the bone tissue and with a sufficient distance from the transition between the bone and soft tissue achieves especially effective anchoring of the implant, thus ensuring the supporting area of the anchoring of the implant in the bone.

Reducing the threads in the sub-areas 2.1 and 2.3 prevents especially mechanical stress peaks in deeper layers of the bone and in the area of the periosteum when inserting or screwing the implant 1 into a hole prepared in the jaw bone.

Also the depth of the threads in the sub-area 2.1 is for example between 0.3 and 0.8 mm and in the sub-area 2.3 at the transition to the emergence area 3 approximately between 0.3 and 0.4 mm. The greatest depth of the threads at the transition between the sub-areas 2.1-2.2 and 2.2-2.3 and in the sub-area 2.2 is for example between 0.3 and 2.5 mm.

In the depicted embodiment, the implant corpus is roughened on the outer surface at least in the enossal area 2, but preferably also in the emergence area 3, namely in the area of the threads both at the points and at the base of the threads. The surface roughening is produced for example by mechanical processing and/or etching and/or coating and/or suitable nanotechnologies.

In general it is also possible to design the threads differently in the individual sub-areas 2.1, 2.2 and 2.3 with respect to the cross-section form of the threads and/or the thread pitch.

As indicated in FIG. 1 by 8.1, the surface line of the outer envelope surface can also be further adapted to the form a natural tooth root.

8.2 designates a notch in the thread, i.e. a recess extending in the longitudinal direction of the tooth implant, which facilitates the insertion of the tooth implant into the bone tissue with its threads.

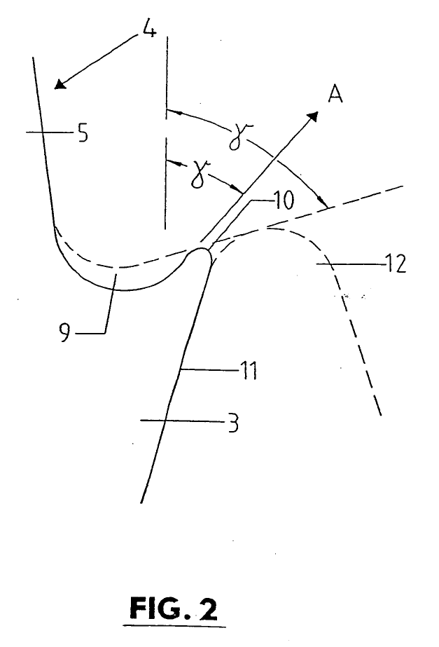

As shown in particular in FIG. 2, the emergence area 3 is designed on its side facing away from the enossal area 2 at the transition area to the retention pin 5 with a groove 9, which encloses the longitudinal axis L in a garland-shaped course, i.e. corresponding to the outer contour of the cross section through a jaw, the base of this groove 9 is located at two opposing groove areas in relation to the longitudinal axis L of the implant 1 in an imaginary reference plane BE extending perpendicular to the longitudinal axis L and in between at a distance from said reference plane, namely offset in the direction of the rounded end 7, where the maximum axial distance between the bottom of the groove 9 and the reference plane BE is between 0.5 and 3.5 mm. The groove 9 is designed along its entire course so that on its outer edge 10 in relation to the longitudinal axis L it transitions into the peripheral or lateral surface 11 of the emergence area 3, and the surface of the groove 9 in the area of the edge 10 forms an angle γ smaller than 90° with the longitudinal axis L, which for example is between approximately 40° and 90° and which opens toward the retention pin 5, so that when fastening the cap 6 to the retention pin, the excess adhesive or cement is pressed by the shape of the groove 9—corresponding to the arrow A in FIG. 2—outward away from the jaw and therefore cannot enter the area between the implant and the soft tissue 12. Excess adhesive or cement can therefore be removed very easily on the outer surface of the soft tissue 12 by means of a suitable tool.

In the depicted embodiment, the threads at the transition of the sub-area 2.3 and of the emergence area 3 or at said emergence area are designed following the garland-shaped course of the groove 9, i.e. the threads are incomplete there, so that threads are provided only where the garland-shaped course of the groove 9 has the smaller distance from the reference plane BE or lies in the reference plane and is increasingly omitted where the distance between the garland-shaped course of the groove 9 and the reference plane is larger.

The increased depth of the threads at the transition between the sub-areas 2.2 and 2.3 and also in the area 2.2 increases the total surface of the flanks of the threads, resulting in the increased anchoring of the implant in the bone tissue in this supporting area of the implant.

The differing depth of the threads is achieved with a constant pitch for example through different flank angles of the threads and/or through a different width of the base of the thread. However, both of these measures can also be combined.

While the core of the enossal area 2 of the implant corpus in relation to the longitudinal axis L is rotationally symmetric in the depicted embodiment, the emergence area 3 has an oval cross section, the cross section dimension 13 of which is smaller than the cross section dimension 14. The cross section dimension 13 corresponds to the buccal/approximal axis and the cross section dimension 14 corresponds to the axis on which also the areas of the garland-shaped course of the groove 9 lie in the reference plane BE.

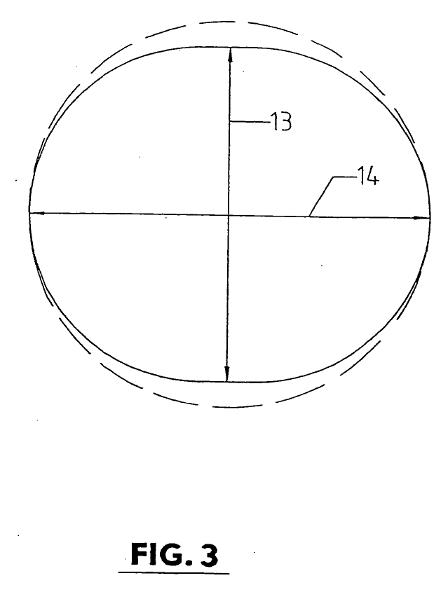

In order to optimally cover a wide variety of applications, the implant 1 is available in different models and sizes, in particular also with different diameters especially in the enossal area 2 and in the emergence area 3, where the cross section in the emergence area 3 in the depicted embodiment is not rotationally symmetric to the longitudinal axis L, but slightly oval, corresponding to FIG. 3 with the smaller cross section axis 13 and the larger cross section axis 14, of which the smaller cross section axis 13 is the buccal/approximal axis and the cross section axis 14 is the axis on which also the areas of the garland-shaped course of the groove 9 lie in the plane BE. The difference D between the length of the cross section axis 14 and the cross section axis 13 is likewise different for implants for different applications. The following table shows sample differences D for implants for different applications:

TABLE 1

| | maximum diameter | maximum diameter | |
|---|---|---|---|
| | of enossal area | of emergence | |
| Implant for | 2 in mm | area 3 in mm | D in mm |
| Lower front | 2.8-4.0 | 3.0-5.0 | 0.3-1.2 |
| tooth | | | |
| Canine, upper/ | 3.6-6.0 | 3.7-6.6 | 0.2-1.8 |
| lower jaw | | | |
| Middle incisor, | 3.6-5.4 | 3.7-6.4 | 0.3-1.6 |
| upper jaw | | | |
| Premolar, upper/ | 3.5-4.7 | 3.6-5.6 | 0.3-1.2 |
| lower jaw | | | |
| Molar, upper/ | 5.0-10.0 | 5.2-13.2 | 0.8-4.8 |
| lower jaw | | | |

Furthermore, the garland-shaped course of the groove 9 is different depending on the use of the implant. The following table shows this course through the distance x from the reference plane BE for different implants:

TABLE 2.1
Distance x from the reference plane in mm

| Upper jaw | No. 1 | No. 2 | No. 3 | No. 4/5 | No. 6/7/8 |
|---|---|---|---|---|---|
| Maximum | 3.7 | 3.7 | 3.5 | 1.6 | 1.4 |
| Minimum | 1.6 | 1.5 | 1.7 | 0.4 | 0.1 |
| Mean value | 2.538 | 2.223 | 2.13 | 1.011 | 0.7 |
| Standard deviation | 0.54 | 0.56 | 0.62 | 0.36 | 0.3 |
| Preferred value | 2.6 | 2.3 | 2.2 | 1.0 | 0.7 |
| Corrected value* | 0.9-2.0 | 0.7-1.9 | 0.6-1.8 | 0.2-1.5 | 0.5-1.2 |

*in connection with a switched scalloped platform

TABLE 2.2
Distance x from the reference plane in mm

| Lower jaw | No. 1/2 | No. 3 | No. 4/5 | No. 6/7/8 |
|---|---|---|---|---|
| Maximum | 4.6 | 4.4 | 2.1 | 2.6 |
| Minimum | 1.4 | 1.8 | 0.5 | 0.5 |
| Mean value | 2.782 | 2.611 | 0.944 | 0.983 |
| Standard deviation | 0.967 | 0.704 | 0.338 | 2.563 |
| Preferred value | 2.8 | 2.6 | 1.0 | 0.9 |
| Corrected value* | 0.9-2.0 | 0.8-2.1 | 0.2-1.5 | 0.1-1.8 |

*through switched scalloped platform

The shape of the retention pin is preferably dependant on the respective use or application of the implant 1. In any case, the retention pin 5 has a cross section that deviates from a circular shape, so that a suitable tool can grip said retention pin for inserting the implant.

A possible cross sectional form of the emergence area is depicted in FIG. 3. Alternately, this section can also be square with rounded corners or completely round.

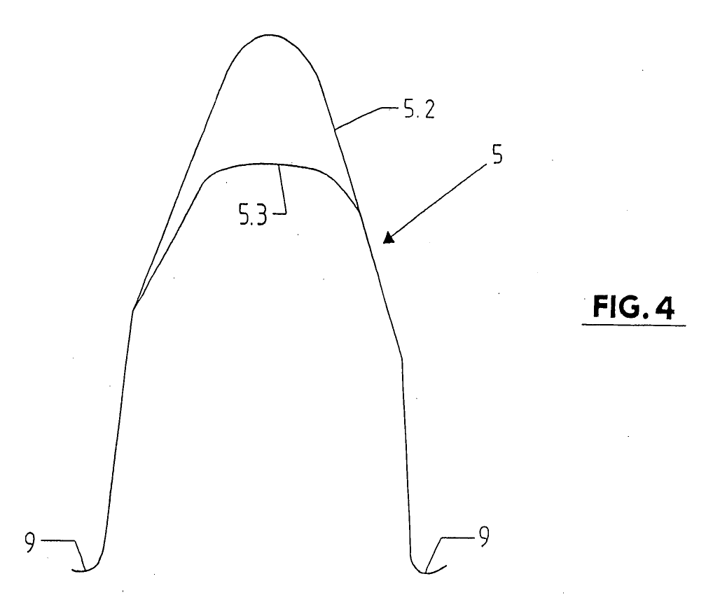

The retention pin has for example a stylized shape adapted to the shape of the tooth to be replaced, as shown again in FIGS. 4-6, wherein:

FIG. 4 shows the stylized shape of the retention pin 5 for a front tooth in frontal view. The retention pin has a tapered form, as indicated by the curve 5.2 or it has a flattened form, as indicated by the curve 5.3. The stylized form of the retention pin in side view, i.e. in an axis direction perpendicular to the view in FIG. 4 is indicated in FIG. 1.

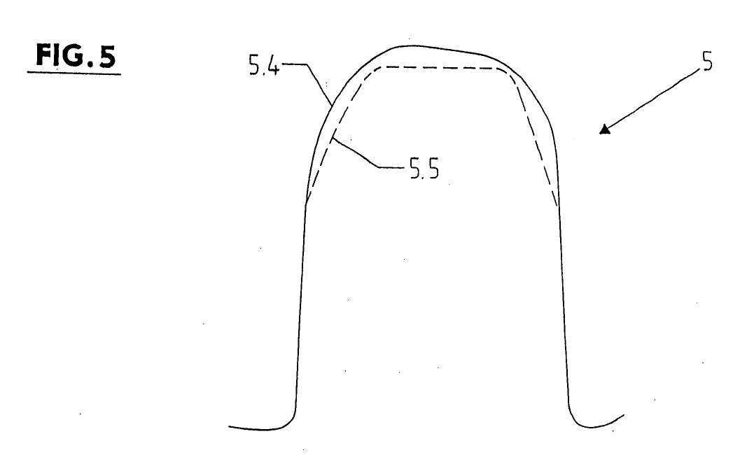

FIG. 5 shows the stylized shape of the retention pin 5 for an implant intended for a premolar. The retention pin 5 in this embodiment has an essentially pin-shaped rounded design on the upper free end corresponding to line 5.4 or a post-shaped design with an approximately truncated cone cross section on the upper free end corresponding to line 5.5. The form in buccal view corresponds to the form in FIG. 5.

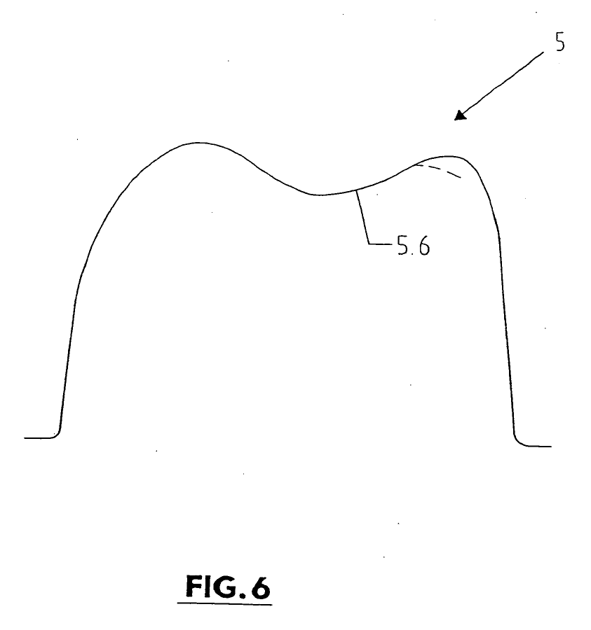

FIG. 6 shows the form of the retention pin 5 for an implant intended for a molar. The retention pin is essentially pin-shaped, but is provided with cusps on the upper free end corresponding to the contour or line 5.6. A slope can be provided instead of the cusps.

In order to enable a positive connection with the respective tool for inserting the implant, the cross section of the respective retention pin is designed so that it deviates from a circular shape, i.e. it is oval or approximately oval.

For an implant 1 that is intended for the front teeth, the retention pin has a flame-shaped design in the buccal/approximal view adapted to the shape of these teeth in a cross section plane, i.e. corresponding to the line 5.1 so that the retention pin 5 is tapered to a point at its free end in this cross section view, namely so that the outer contour of the retention pin is formed on the inner, lingual side by two slanted surfaces, both of which form an angle smaller than 90° with the reference plane BE, said angle opening toward the longitudinal axis L, where the respective angle of the surface 15 following the emergence area 3 is somewhat larger than the corresponding angle of the adjacent surface 16 transitioning into the tip 17. The tip 17 lies in the area of the longitudinal axis L. On the other side, the contour of the retention pin 5 is formed by a slanted surface 18 that is slightly convex on the outer side. In a cross section plane perpendicular to the buccal/approximal plane the retention pin 5 for the front teeth has an essentially trapezoidal cross section. Also for use in premolars and molars the retention pin has the trapezoidal cross section in both cross section planes.

The described shape of the retention pin for the implant for the front teeth makes it possible to design the cap fastened with the retention pin 5 corresponding to the anatomical form while maintaining sufficient preparability.

Generally it is also possible to flatten the retention pin on its free end, as indicated by line 17.1.

It is also possible to form the retention pin 5 corresponding to the anatomical form of the natural teeth, where said retention pin then for example has the dimensions listed in the following tables.

In an embodiment of the invention, the starting point for the form of the retention pin 5 is the natural tooth form. Compared with the contour of the natural tooth form, the retention pins are reduced in size by a certain dimension, which is for example between 0.1 and 5.5 mm, although this dimension does not exceed the usual material thickness of the retention pin 5 plus the shell of a single crown, bridge element, telescope, etc. Details are shown in the following table:

TABLE 3

| | Retention | Mesio-distal | Labio-buccal-oral |
|---|---|---|---|
| | pin | diameter at | diameter at |
| Tooth | length | transition to area 3 | transition to area 3 |
| Upper jaw | | | |
| Middle incisor | 10.5-2.0 | 5.0-1.2 | 1.3-7.0 |
| Side incisor | 9.5-2.0 | 1.0-4.8 | 1.1-5.2 |
| Canine | 11.0-2.0 | 1.2-6.0 | 1.3-7.0 |
| First premolar | 9.5-2.0 | 1.2-6.0 | 1.2-7.0 |
| Second premolar | 9.5-2.0 | 1.2-6.0 | 1.2-7.0 |
| First molar | 10.0-2.0 | 9.0-3.0 | 10.0-3.0 |
| Second molar | 10.0-2.0 | 9.0-3.0 | 10.0-3.0 |
| Third molar | 10.0-2.0 | 8.5-2.5 | 2.5-8.5 |
| Lower jaw | | | |
| Middle incisor | 10.0-2.0 | 1.0-5.0 | 1.1-6.2 |
| Side incisor | 11.0-2.0 | 1.0-5.0 | 1.1-6.2 |
| Canine | 11.0-2.0 | 1.2-5.0 | 1.3-7.0 |
| First premolar | 9.0-2.0 | 1.2-6.0 | 1.3-7.0 |
| Second premolar | 9.0-2.0 | 1.2-6.0 | 1.3-7.0 |
| First molar | 10.0-2.0 | 3.0-10.0 | 3.0-11.0 |
| Second molar | 10.0-2.0 | 3.0-11.0 | 3.0-10.0 |
| Third molar | 10.0-2.0 | 3.0-11.0 | 3.0-10.0 |

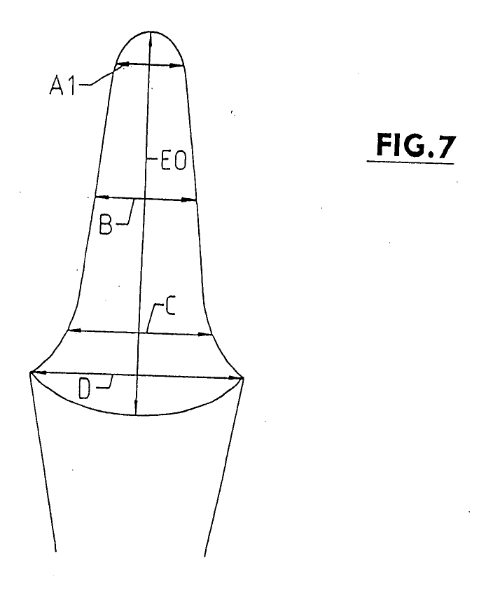

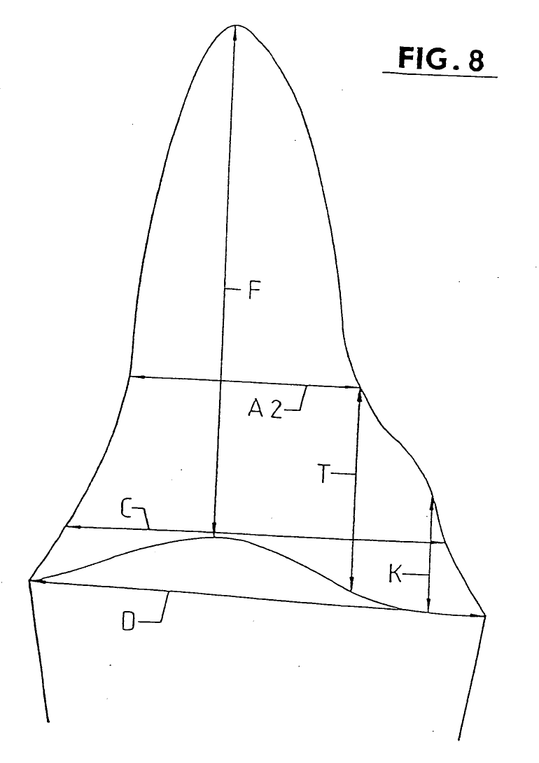

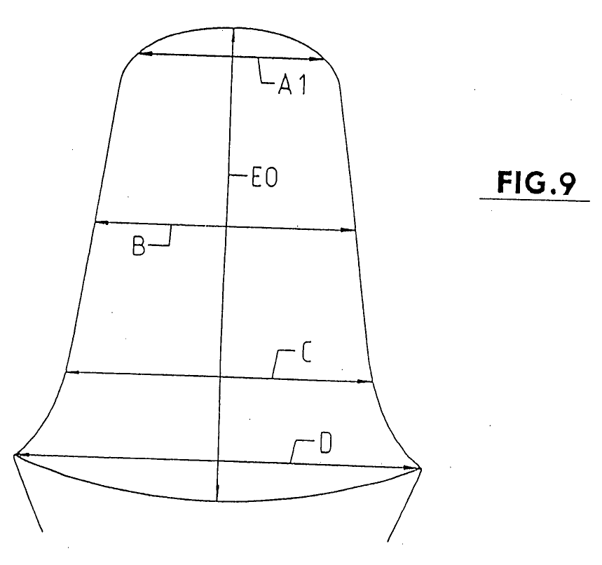

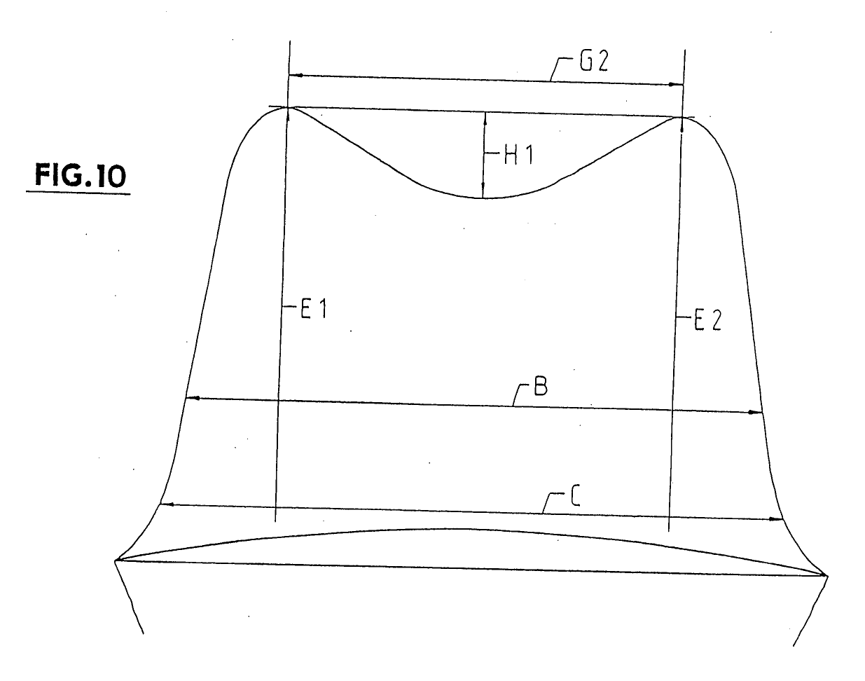

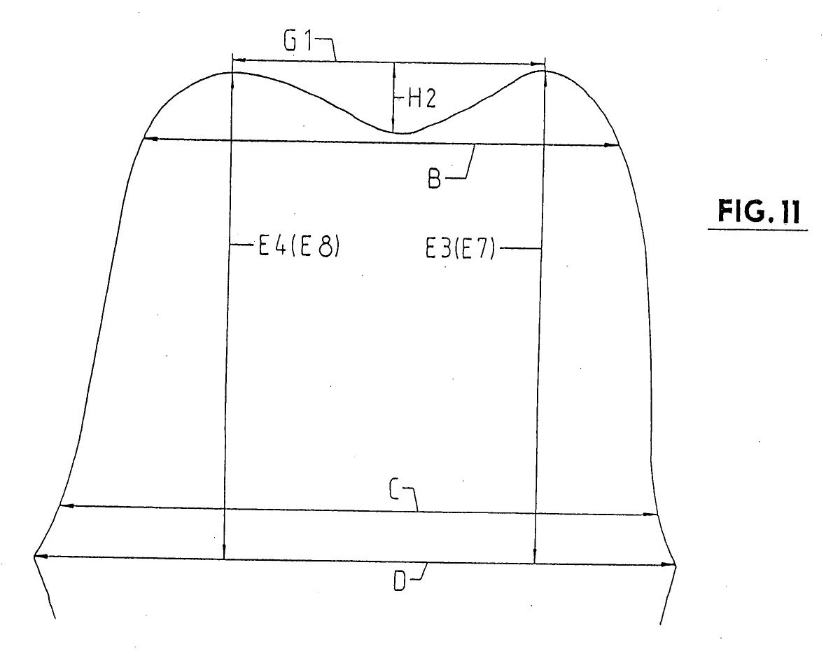

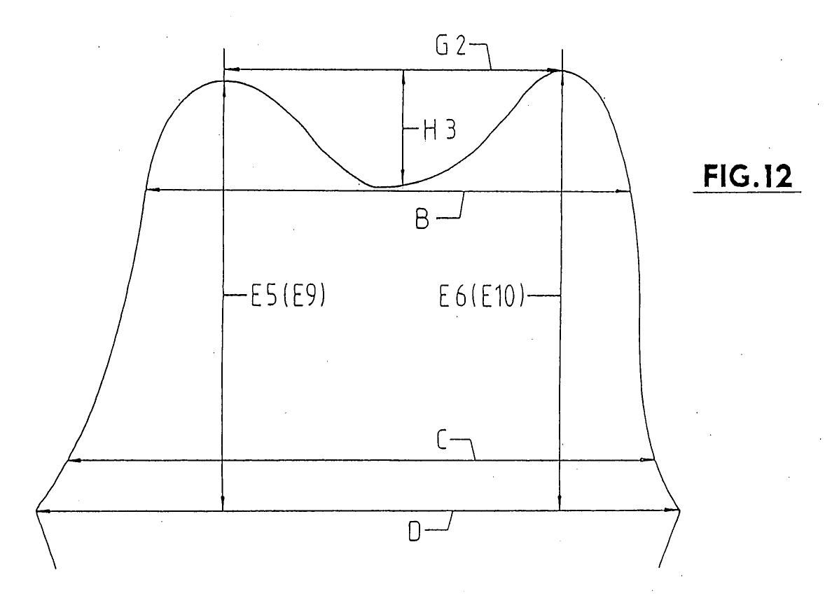

Further examples for the shape of the retention pin adapted more nearly to the anatomical tooth form are described in FIGS. 7-12 and Tables 4 through 15. In these drawings, the respective depicted retention pins are dimensioned; the following legend applies to the drawings and tables 4 - 15:
A1=diameter of the retention pin at the top or tip in labial view;
A2=diameter of the retention pin at the height of the start of the Tuberculum dentis in side view;
B=diameter of the retention pin in the middle of the pin for an implant for front teeth and premolars; for an implant for molars, at the transition of the cusps to the body/corpus of the pin;
C=diameter of the retention pin at the stage or in the area of the base;
D=diameter of the retention pin at the largest circumference at the transition to the emergence area 3;

E0=height of the retention pin measured between the lowest point of the garland-shaped groove 9 and top side or tip of the retention pin in labial or buccal, lingual and palatinal view for an implant for front teeth and premolars;
F=height of the retention pin measured between the highest point of the garland-shaped groove 9 to the top of the retention pin;
G1=cusp distance from buccal-palatinal/lingual view for an implant for molars;
G2=cusp distance from mesial-distal view for an implant for premolars and molars;
H1=depth of the saddle formed by the cusps on the top of the retention pin for an implant for premolars;
   Especially for an Implant for Premolars:
E1=height of the buccal cusps from side view;
E2=height of the palatinal cusps from side view;
   Especially for an Implant for Molars:
Buccal view:
E3=height of the retention pin measured between the transition to the emergence area 3 and the mesio-buccal cusp;
E4=height measured between the transition to the emergence area 3 and the disto-buccal cusp
   Lingual View:
E7=height of the retention pin measured between the transition to the emergence area 3 and the mesio-palatinal/lingual cusp;
E8=height of the retention pin measured between the transition to the emergence area 3 and the disto-palatinal/lingual cusp;
   Mesial Approximal View:
E5=height measured between the transition to the emergence area 3 and the mesio-buccal cusp;
E6=height measured between the transition to the emergence area 3 and the mesio-palatinal/lingual cusp;
   Disto-Buccal View:
E9=height measured between the transition to the emergence area 3 and the disto-buccal cusp
E10=height measured between the transition to the emergence area 3 and the disto-palatinal/lingual cusp
H2=depth of the saddle in buccal view or palatinal/lingual view
H3=depth of the saddle in side view from mesial and distal view
   Especially for an Implant for Incisors:
I=height of start of Tuberculum dentis
L=height of end of Tuberculum dentis

All values listed in Tables 4 through 15 are in millimeters. Deviations from the values listed in Tables 4-15 on the order of 0 to 3 millimeters are possible in this embodiment.

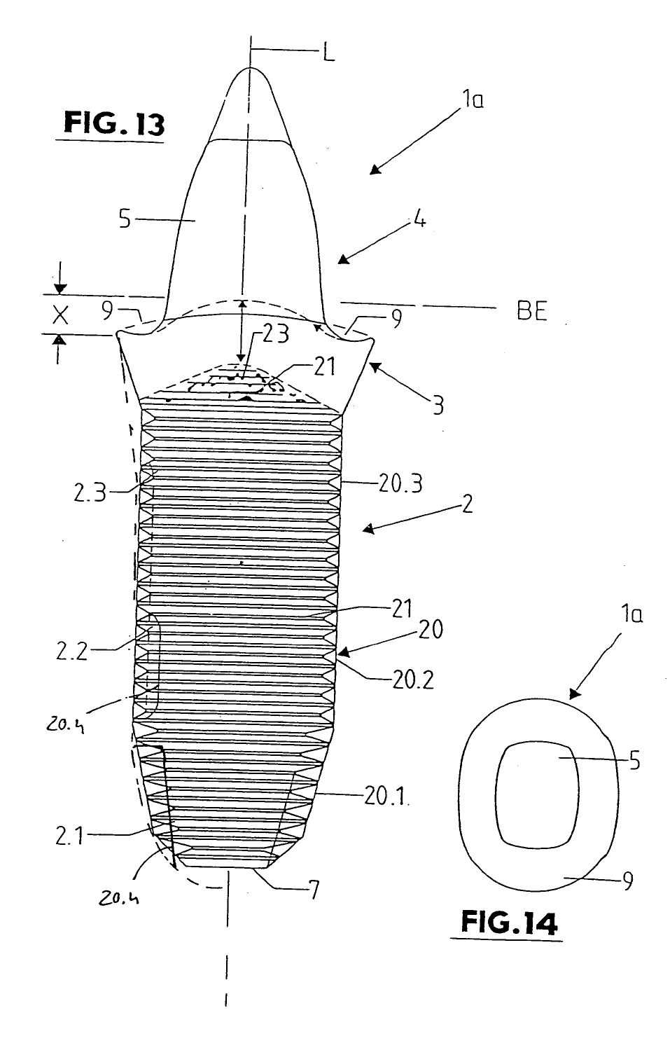

FIG. 13 shows in a depiction similar to FIG. 1 a further possible embodiment of the implant la according to the invention, which again is manufactured from a suitable material for a tooth implant, for example of metal or ceramic, e.g. of titanium and/or zirconium oxide and/or aluminum oxide, namely with the enossal area 2, the adjoining middle area or emergence area 3, with which the implant la emerges through the soft tissue after implanting and healing, and the coronal area 4, which again is formed essentially by the retention pin 5.

The enossal area 2 in the depicted embodiment consists in this embodiment also of three sub-areas, which adjoin in longitudinal direction L, each of which has essentially the same axial length L and each of which is provided with outer threads, namely of the apical sub-area 2.1 furthest away from the coronal area 4, of an adjoining alveolar sub-area 2.2 and of an adjoining coronal sub-area 2.3, which then also in this embodiment adjoins emergence area 3, which has an increasing diameter in the form of a truncated cone in the direction of the retention pin. The threads, as shown in FIG. 13, are provided also at the transition between the coronal sub-area 2.3 and the emergence area 3 and partially on the latter, so that the threads on the visible side as depicted in FIG. 13 and the opposite side (inter-tooth area), i.e. where the distance between the garland-shaped bottom surface of the groove 9 and the reference plane BE is greatest, are still present, but then extend to the other two sides (front and back). Also, the threads at the emergence area increasingly change gradually into a roughened surface.

Notches are again designated by 20.4.

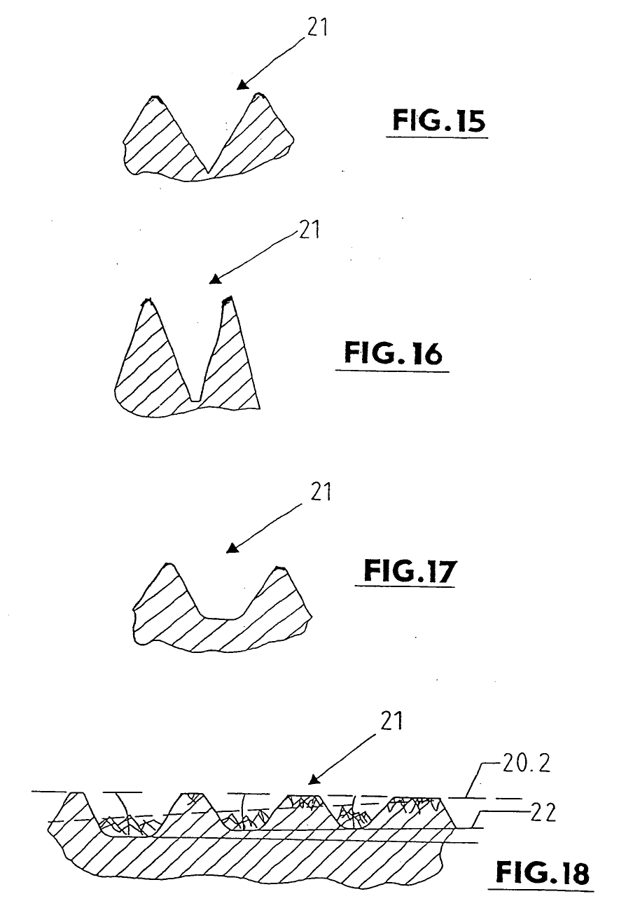

A special feature of the implant 1a is the fact that not the core of the enossal area 2, but rather the envelope, designated 20 in FIG. 13, on which the free ends of the threads are located, is designed so that the envelope 20 is formed in the sub-area 2.1 by a sub-area 20.1 increasing in the form of a truncated cone toward the retention pin 5, in sub-area 2.2 by a cylindrical or essentially cylindrical sub-area 20.1 and in sub-area 2.3 by a likewise increasing sub-area 20.3 toward the retention pin 5. Moreover, the threads have a shape that changes along the enossal area, namely for example with a constant pitch of these threads. FIG. 15 shows in a very schematic representation the design of the threaded area 21 in the lower part of the sub-area 2.1. As depicted, the threads are designed with an angular profile with pointed tapered ends and with essentially straight side surfaces. FIG. 16 shows the design of the threaded area 21 in the upper part of the sub-area 2.1, i.e. at the transition to section 2.2, where the threads have the greatest depth. In general, the depth of the threads in the sub-area 2.1 is approximately 0.3-0.8 mm.

The pointed, i.e. blade-like design of the profile of the threads, prevents tensions when screwing the implant 1a into the jaw.

FIG. 17 shows the design of the threaded area 21 in the sub-area 2.2. The threads there have a smaller depth than those depicted in FIG. 16. The threads likewise have a pointed tapered design. However, the bottom area between the threads is flatter.

FIG. 18 shows the threaded area 21 again in the middle area of the sub-area 2.2. As depicted, the free ends of the threads are located on the cylindrical sub-area 20.2 of the envelope 20, i.e. the free ends of the threads each have a consistent radial distance from the longitudinal axis of the implant. With increasing distance from the sub-area 2.1 the radial distance between the bottom formed between the threads and the axis of the implant increases, i.e. the bottom of the threads is located on an imaginary conical surface concentrically enclosing the axis of the implant, with a conical radius that increases toward the retention pin 5. FIG. 18 also shows that the volume of the threads in the direction of the retention pin 5 increases as compared with the intermediate space between the threads, i.e. the threads widen in axial direction and the intermediate space becomes smaller.

FIG. 19 shows the design of the threaded area 21 in the sub-area 2.3. As mentioned above, the free, flattened ends of the threads in this sub-area are located on the increasing truncated cone section 20.3 of the envelope 20. The bottom of the threads in this embodiment is likewise located on an imaginary conical surface with a conical radius that increases with increasing proximity to the retention pin 5.

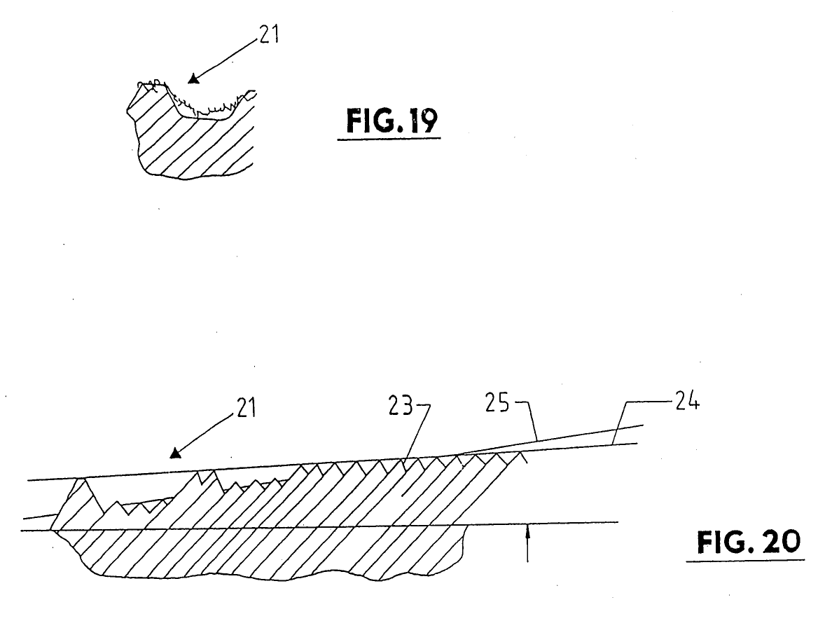

FIG. 20 shows the design of the threaded area 21 at the emergence area 3 and at the transition between the sub-area 2.3 and the emergence area, namely where the threads are still provided. FIG. 20 also shows the transition of the threads into the roughened surface 23.

The free ends of the threads and also the roughened surface are both located on a conical surface concentrically enclosing the longitudinal axis of the implant, as indicated by the line 24. The bottom of the threaded area 21 is likewise located on an imaginary conical surface with an increasing diameter in the direction of the retention pin 5, as indicated by the line 25; however, the conical angle of the conical surface 25 is greater than the conical angle of the conical surface 24, so that the depth of the threads decreases in the direction of the retention pin 5.

As indicated especially in FIG. 18, the threaded area 21 can be roughened over the entire length or over several partial lengths, both on the threads and on the bottom. This roughened surface, as the roughened surface 23, is then produced by various techniques, for example by mechanical processing and/or chemical processing and/or by application of particles that produce a roughened surface, for example by the application of nanoparticles made of aluminum oxide or zirconium oxide, for example by spattering.

Both the implant 1 and the implant 1a can be coated on the outer surface, namely with a tooth-colored coating corresponding to the tooth colors A2-A4, for example with a corresponding coating or layer made of zirconium oxide. It is also possible to manufacture the respective implant 1 or 1a completely from this material corresponding to the tooth colors A2-D4, e.g. from zirconium oxide.

It was assumed in the above description that the enossal area 2 of the implant 1 or 1a has a rotationally symmetrical design in relation to the longitudinal axis L, i.e. a circular or conical cross section. It is generally also possible to design this area so that it is oval or square.

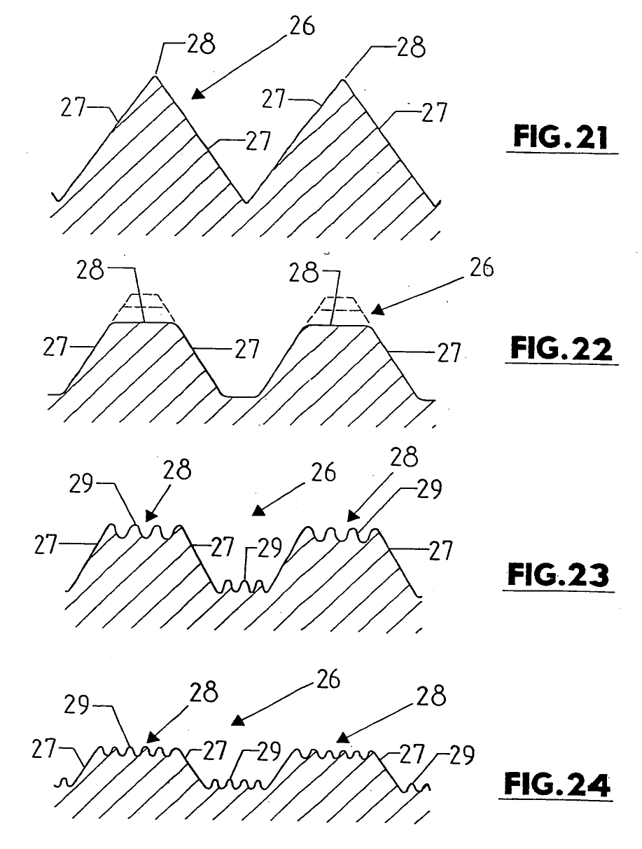

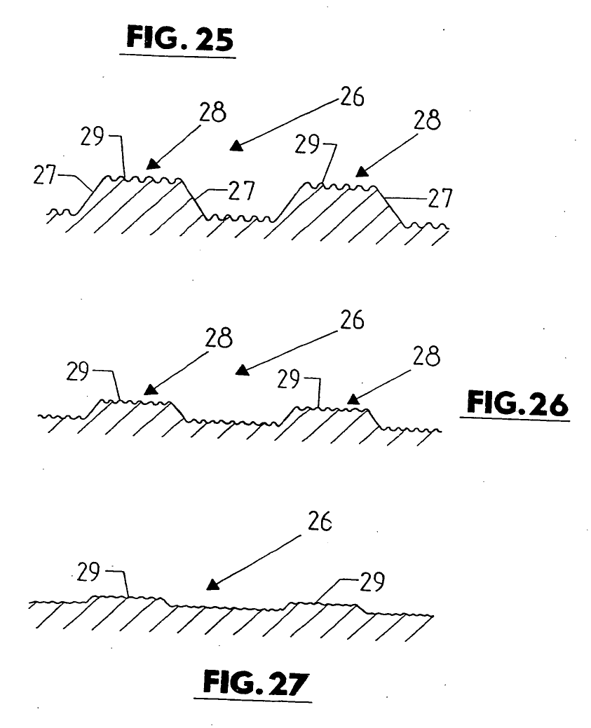

FIGS. 21-27 each show a simplified view of the profile or cross section of the threads 26 corresponding to the threaded area 21, namely with increasing distance from the rounded end 7 of the implant. The profile in the area of the end 7 is shown in detail in FIG. 21. The threads there have an approximately triangular profile cross section with side flanks 27 extending diagonally to the cross section plane of the implant and joining each other at a tapered or slightly rounded radial outer apex surface 28.

FIG. 22 shows the profile of the threaded area 26 at a somewhat greater distance from the end 7. The threads there are flattened at the apex area 28, resulting in a trapezoidal cross section for the threads.

FIG. 23 shows the threaded area 26 at a somewhat greater distance from the end 7 than in FIG. 22. The threads 26 are still trapezoidal, however the threaded area 26 on the radial outer surfaces of the threads and with increasing distance from the end 7 is also provided with a roughened surface 29 (FIG. 24) between the threads.

With increasing distance from the end 7, for example in the area designated 20.1 in FIG. 13, the depth of the threads 26 and the depth of the roughened surface 29 both decrease, so that in the emergence area 3 the threads 26 have a minimal height only in partial areas and then with increasing distance from the end 7 essentially only the profiling or roughening 29 exists. The latter then extends at least over a partial area of the outer surface of the emergence area 3.

The depth of the surface roughening is, for example, between 0.18 and 0.38 mm. In the embodiment depicted in FIGS. 21-27 the surface roughening 29 is formed by a multi-turn threaded area or by threads of such a threaded area.

A distinctive feature of this embodiment of the invention is for example that the threads 26 have a consistent pitch throughout, i.e. the distance between two adjacent threads over the entire length of the implant is constant or essentially constant, and that the threaded area 26 starting at a certain distance from the end 7, for example starting with the area 20.2 in FIG. 13, is provided with a surface roughening or profiling 29, the size or depth of which, just as the height of the threads, decreases with increasing distance from the end 7.

A roughness profile then connects to the threads 26 at the upper end of the emergence area, with a roughness between 0.05 and 0.38 μm for supporting the soft tissue.

The invention was described above based on exemplary embodiments. It goes without saying that numerous modifications or variations are possible without abandoning the underlying inventive idea upon which the invention is based.

It was assumed above that the tooth implant is designed as one piece; however, it can also have a multi-part design, e.g. a two-part design.

It is possible, for example, that the threads and/or the roughened area has a wave-shaped course with a decreasing depth toward the coronal end.

### REFERENCE TERMS

1 implant
2 enossal area
2.1 apical sub-area
2.2 alveolar sub-area
2.3 coronal sub-area
3 emergence area
4 coronal area
5 retention pin
5.1 special form of the retention pin for implants for front teeth
6 cap
7 rounded end
8 surface line
9 groove
10 edge
11 lateral surface of emergence area 3
12 soft tissue
13, 14 cross-sectional axis
15, 16 surface
17 tip
17.1 flattened tip
18 front surface
20 envelope
20.1, 20.2, 20.3 envelope section
21 threaded area
22 envelope
23 surface roughening
24, 25 envelope
26 threads
27 flank of threads
28 radially outer apex surface of threads
29 surface roughening or structuring
L longitudinal implant axis
α,β, γ angle

What is claimed is:

1. A tooth implant with an implant corpus, which forms in its longitudinal axis (L) consecutively at least one enossal area that can be anchored in a bone, a emergence area for emergence through a soft tissue and a coronal area with retention pins, and the enossal area forming at least three threaded sub-areas consecutively adjoining in the direction of the longitudinal axis (L).
wherein the core of the implant corpus in both an apical sub-area and in the a coronal sub-area has a cross section that increases in at least one cross section axis to the coronal area and has an essentially constant cross section in an alveolar sub-area in between, and that free ends or points of threads are located on a common enveloping surface enclosing the longitudinal axis (L), said enveloping surface having a largest distance from the core of the implant corpus at a transition between the coronal sub-area and the alveolar sub-area and/or at the transition between the alveolar sub-area and the apical sub-area and/or at the alveolar sub-area.

2. The implant according to claim 1, wherein on an outer surface of an envelope curve enclosing the longitudinal axis (L) there is located threads and that the envelope curve in the apical sub-area and in the coronal sub-area has a cross section that increases at least in a axis direction radially to the longitudinal axis (L) in the direction toward the coronal area, and has an essentially constant cross section in the alveolar sub-area in between.

3. A tooth implant with an implant corpus, which forms in its longitudinal axis (L) consecutively at least one enossal area that can be anchored in a bone, a emergence area for emergence through a soft tissue and a coronal area with retention pins, and the enossal area forms at least three threaded sub-areas consecutively adjoining in the direction of the longitudinal axis (L), wherein
on an envelope curve enclosing an outer surface of the longitudinal axis (L) there is located threads and that the envelope curve in an apical sub-area and in a coronal sub-area has a cross section that increases at least in one axis direction radially to the longitudinal axis (L) in the direction toward the coronal area, and has an essentially constant cross section in the alveolar sub-area in between.

4. The implant according to claim 3, wherein a core of the implant corpus in the apical sub-area and in the coronal sub-area has a cross section that increases in at least one cross section axis to the coronal area and in the alveolar sub-area in between has an essentially constant cross section, and that points of the threads are located on a common enveloping surface enclosing the longitudinal axis (L), said surface having the largest distance from the core of the implant corpus at the transition between the coronal sub-area and the alveolar sub-area and/or at the transition between the alveolar sub-area and the apical sub-area and/or at the alveolar sub-area.

5. The implant according to claim 3, wherein the core of the implant corpus both in the apical sub-area and in the coronal sub-area has a cross section that increases in the form of a truncated cone in the direction toward the coronal area, and in the alveolar sub-area in between has an essentially constant cross section.

6. The implant according to claim 3, wherein the enveloping curve both in the apical sub-area and in the coronal sub-area is formed by an envelope curve section that increases in the form of a truncated cone, and in the alveolar sub-area is formed by a cylindrical envelope curve section.

7. The implant according to claim 3, wherein the envelope curve is convexly curved on its outer surface facing away from the core of the implant corpus.

8. The implant according to claim 3, wherein the sub-areas of the enossal area all have the same or approximately the same axial length.

9. The implant according to claim 3, wherein the cross sections of the implant corpus in the enossal area is rotationally symmetrical to the longitudinal axis (L).

10. The implant according to claim 3, wherein it has a maximum diameter of approximately 2.8 to 9 millimeters in the enossal area.

11. The implant according to claim 3, wherein the implant corpus is roughened at least in the enossal area or along its entire length.

12. The implant according to claim 3, wherein the threads in the apical sub-area have a depth between 0.4 and 0.8 mm.

13. The implant according to claim 3, wherein the threads at the transition between the coronal sub-area and the emergence area have a depth of approximately 0.3 to 0.4 mm.

14. The implant according to claim 3, wherein the emergence area increases in diameter in the form of a truncated cone toward the retention pin.

15. The implant according to claim 3, wherein the emergence area has an oval cross section that deviates from the a circular form, and the a smaller cross section axis is the a buccal/approximal axis.

16. The implant according to claim 15, wherein a difference between the cross section axes for an implant for front teeth is between 0.3 and 1.2 mm, for an implant for canines is between 0.3 and 1.6 mm, for an implant for a premolar is between 3.8 and 4.7 mm and for an implant for molars is between 0.3 and 8 mm.

17. The implant according to claim 3, wherein at the emergence area at the transition to the retention pin, a groove enclosing the longitudinal axis (L) of the implant is formed, namely as an edge support for a cap placed on the retention pin, and that the groove forms a surface on its outer edge that forms an angle with the longitudinal axis (L) smaller than 90° opening toward the retention pin.

18. The implant according to claim 17, wherein the groove transitions via an outer edge into the a lateral surface of the emergence area.

19. The implant according to claim 17, wherein the groove has a garland-shaped course, namely wherein the groove lies in a reference plane (BE) intersecting the implant axis (L) perpendicularly in an inter-tooth area of the implant, and in between has a distance (x) from a side of the reference plane (BE) facing away from the retention pin.

20. The implant according to claim 3, wherein the implant is manufactured from metal, or titanium.

21. The implant according to claim 3, wherein the implant is manufactured from a non-metal, zirconium oxide.

22. The implant according to claim 3, wherein the threads have a depth that increases from the free end of the apical sub-area toward the transition between the apical sub-area and the alveolar sub-area.

23. The implant according to claim 3, wherein the threads in the apical sub-area are pointed threads.

24. The implant according to claim 3, wherein the threads are formed at least partially by flattened threads.

25. The implant according to claim 3, wherein a width of the threads in the alveolar sub-area increases with increasing proximity to the coronal sub-area.

26. The implant according to claim 3, wherein a bottom of the threads in the alveolar sub-area is provided on a conical surface that widens in the direction toward the retention pin.

27. The implant according to claim 3, wherein the threads have flattened threads in the coronal sub-area.

28. The implant according to claim 3, wherein a threaded area is provided else at the emergence area, that free ends or points of the threads are located on a surface line defining a porcupine shape of the emergence area and bottoms of the threads are located on a further conical surface, where a conical angle of a further conical surface is larger than a conical angle of the emergence area.

29. The implant according to claim 3, wherein a threaded area transitions into a roughened surface at the emergence area.

30. The implant according to claim 3, wherein a surface roughening of the implant is produced by mechanical treatment, chemical surface treatment, and/or by an application of material, or by the an application of nanoparticles.

31. The implant according to claim 3, wherein the implant is a color of a tooth at least on its outer surface at least in the emergence area and/or in the an area of the retention pin corresponding to the tooth colors A2-D4.

32. The implant according to claim 3, wherein the enossal area is rotationally symmetrical to the longitudinal axis (L).

33. The implant according to claim 3, wherein the enossal area has an oval or slightly oval cross section.

34. The implant according to claim 3, wherein at least one threaded area is provided and has a constant or essentially constant pitch over the entire length of the implant or a majority of the length.

35. The implant according to claim 3, wherein a depth of at least one threaded area decreases with increasing distance from an end furthest away from the emergence area.

36. The implant according to claim 3, wherein the threads of at least one threaded area are increasingly flattened or rounded on a radially outer surface of the threads with increasing distance from an end furthest away from the emergence area.

37. The implant according to claim 3, wherein the threads of at least one threaded area in a proximity of end furthest away from the emergence area have a triangular or essentially triangular cross section and a trapezoidal cross section at a greater distance from said end.

38. The implant according to claim 3, wherein at least one threaded area is provided with a roughened surface, and that a depth of the roughened surface decreases with increasing distance from an end furthest away from the emergence area.
